(19) United States
(12) Patent Application Publication
(10) Pub. No.: US 2024/0383190 A1
(43) Pub. Date: Nov. 21, 2024

(54) PROCESS FOR MANUFACTURING A BOARD ELEMENT COMPRISING CAVITIES

(71) Applicant: Ceraloc Innovation AB, Viken (SE)

(72) Inventors: Per JOSEFSSON, Ramlösa (SE); Per NYGREN, Ramlösa (SE)

(73) Assignee: Ceraloc Innovation AB, Viken (SE)

(21) Appl. No.: 18/663,063

(22) Filed: May 14, 2024

(30) Foreign Application Priority Data
May 15, 2023 (SE) 2350588-6

(51) Int. Cl. B29C 63/02; B29C 59/02; B29C 63/00; B29L 7/00

(52) U.S. Cl. CPC B29C 63/02; B29C 59/026; B29C 2063/0008; B29C 2793/009; B29L 2007/002

(57) ABSTRACT

A process for manufacturing a board element. The process includes providing a substrate including a polymer-based material and a plurality of cavities in a rear side, arranging a printing pattern on a front side of the substrate, and coordinating a position of the printing pattern with a location of the cavities.

### TECHNICAL FIELD

The disclosure relates to a process for manufacturing a board element, which may be a panel or may be dividable into at least one panel. The board element comprises a substrate comprising a polymer-based material, such as a thermoplastic material or a thermosetting material, a plurality of cavities in a rear side thereof, and a printing pattern on a front side. The panel may be a building panel, floor panel, wall panel, ceiling panel or furniture component.

### BACKGROUND

It is known how to synchronize a print sheet with an embossing roller in the context of building panels, such as floor panels. For example, the disclosures WO 2023/191697 A1 and WO 2023/234834 A1 describe methods to produce a laminated substrate or panel with an embossed structure. A printed polymer-based film is applied on a substrate comprising a polymer-based material, and the laminated substrate is embossed by an embossing device such that it obtains an embossed structure. The teachings of these disclosures may for example provide an increased number of pattern variations of laminated structure.

However, a typical substrate in the prior art is essentially uniform, for example having a substantially constant thickness, whereby characteristics of the substrate are essentially identical at all points of a front side thereof and an accurate application of the print, such as a print sheet, thereon is usually not needed. However, improvements of the application of a print on a substrate may be desired when a board element comprises weight-reducing cavities, such as impressed cavities, in a rear side of the board element. Indeed, in this case the characteristics of the substrate, such as its thickness, may vary along the front side. Such cavities or grooves may be formed by removing material, such as described in the disclosures WO 2013/032391 and WO 2014/007738, by impression as described in WO 2023/249536 A1, or by shaping a material for forming protrusions in a rear side of a substrate and thereby creating a cavity region between the protrusions as described in WO 2024/091174 A1.

### SUMMARY

It is therefore an object of at least embodiments of the present disclosure to provide a more controlled process for arranging a décor structure, preferably comprising a print layer or a digital print, on a board element comprising weight-reducing and/or material saving cavities. Alternatively, or additionally, the cavities may reduce a volume of the board element, such as compared to a board element having a constant thickness without any cavities. For example, the cavities may improve the sound characteristics of the board element.

Another object of at least embodiments of the present disclosure is to provide a more controlled process for dividing a board element comprising such cavities and, preferably, a décor structure.

These and other objects and advantages that will be apparent from the description have been achieved by the various aspects, embodiments and examples described below. In accordance with a first aspect of the disclosure, there is provided a process for manufacturing a board element. The process comprises providing a substrate comprising a polymer-based material, such as a thermoplastic material, and a plurality of cavities in a rear side of the substrate, arranging a printing pattern on a front side of the substrate, and coordinating a position of the printing pattern with a location of the cavities.

Thereby, a weight-reduced and/or material saving and/or volume reducing board element comprising the substrate and the printing pattern may be obtained. By means of the coordination of the printing pattern and the cavities, the décor structure may be arranged on the board element in a more precise manner. Additionally, the décor structure may become better positioned with respect to a dividing portion, at which the board element is adapted to be divided into one or several board members or panels. In view of the above, the arranging of the décor structure on the board element as well as the dividing process may become more controlled.

The coordination may be included in the act of arranging the printing pattern on the front side. The cavities may be preformed in the substrate, or they may be created in the substrate during the process, such as by impressing, shaping or removing material from the substrate. Generally herein, the printing pattern may be arranged on the front side after or while creating the cavities, but arranging it before their creation is also equally conceivable.

The substrate may be a core of the board element on which the printing pattern, such as a print layer or a digital print, may be directly arranged. Alternatively, the printing pattern may be arranged directly on a substrate in the form of an upper layer of the board element attached, such as laminated or adhered, to a front side of a core of the board element.

The printing pattern, and optionally a wear layer applied thereon, may provide a décor structure of the board element, such as panel. The wear layer may contribute to a wear-resistant décor structure.

The board element may be provided in the form of a panel or may be dividable into at least one panel, such as at least two panels, optionally via a board member, which preferably has a smaller (larger) format than the board element (panel). Each panel may be a building panel, floor panel, wall panel, ceiling panel or furniture component. For example, a plank, a slab and a tile are included as examples of a panel.

Throughout the present disclosure, the wording “cavity” may be construed as a recess, groove, depression, notch, indentation, cut, etc. The cavities may be open towards a rear side of the board element.

The act of arranging the printing pattern on a front side of the substrate may comprise digitally printing the front side of the substrate, such as by inkjet printing.

The act of arranging the printing pattern on a front side of the substrate may comprise applying a print layer on the front side of the substrate. The print layer may comprise the printing pattern, which preferably is a predetermined printing pattern. For example, the printing pattern on the print layer may be digitally printed or may be formed by rotogravure.

The print layer may be a printed polymer-based sheet, such as a foil or a film.

The print layer may be continuously applied to the substrate, such as by means of a print application unit comprising rollers.

The print layer may comprise print layer sections, such as a plurality thereof. At least one print layer section comprising the printing pattern may be applied on the front side of the substrate. The print layer sections may be clearly distinguished from each other, such as by edge sections and/or marks. The print layer may be configured to be cut at the edge sections, such as while dividing the board element.

The printing pattern may be repeated in the print layer sections. Thereby, the printing patterns of the print layer sections may be essentially identical.

The printing pattern may be repeated as regions, such as print layer sections, separated by edge sections. The cavities may form a cavity pattern that is repeated as regions separated by separation portions. The coordinating may include arranging the edge sections and the separation portions at essentially same horizontal positions.

A format of the print layer, such as of a print layer section, may be essentially adapted to a size of the front side of the substrate or board element or panel.

Any of the printing patterns above may be continuous, whereby the printing patterns of adjacent print layer sections are continuously transformed into each other. Alternatively, they may be discontinuous, whereby the printing patterns of adjacent print layer sections are interrupted discontinuously.

In some embodiments, the printing pattern may vary between the print layer sections.

The printing pattern herein, in particular the digitally printed pattern or the printing pattern of the print layer, may comprise a wood pattern simulating wood, a stone pattern simulating stone, or any other pattern. For example, the wood pattern may comprise grains, knots, medullary rays, and other wood-like structures.

The process may further comprise creating the cavities in the rear side by impressing a substrate portion by an impression device comprising impression elements and/or arranging the printing pattern on the front side by a print application unit. Alternatively, the cavities may be created by removing material from the substrate by a processing tool, such as a rotating cutting device, or by shaping material in a shaping member.

The print application unit may be synchronized with the impression device, shaping member or processing tool for obtaining the coordination of the printing pattern and the cavities.

The process may further comprise determining a print schedule based on location data of the cavities and/or position data of a print layer.

The process may further comprise controlling the arranging of the printing pattern on the front side of the substrate based on a, preferably determined, print schedule, for example by controlling a print application unit. Thereby, the position of the printing pattern and the location of the cavities may be coordinated in a more precise manner.

The coordinating may include sensing a first position of the printing pattern and/or of a device configured to form the printing pattern, sensing a second position of the cavities and/or of a device configured to form the cavities, and adjusting a formation of the printing pattern and/or of the cavities based on the first and second positions. Generally herein, the device configured to form the printing pattern may be, for example, a print application unit, a digital printing unit, or similarly.

The process may further comprise applying a wear layer on the printing pattern. Optionally, the application of the wear layer may be based on the, preferably determined, print schedule. For example, a wear application unit may be controlled based thereon.

The wear layer may be a polymer-based sheet, such as a foil or a film. Alternatively, the wear layer may be a coating, for example an electron beam (EB) coating or a radiation cured coating, such as an ultraviolet (UV) coating.

The process may further comprise embossing at least a portion of the substrate comprising the printing pattern and, optionally, a wear layer.

The process may further comprise embossing at least a portion of the substrate comprising the printing pattern and, optionally, a wear layer, such that an embossed structure in register with the printing pattern is obtained. A position of the embossed structure may be coordinated with the location of the cavities. Thereby, an embossing-in-register, EIR, may be obtained, which may contribute to a more realistic design of the décor structure. The embossed structure may comprise depressions and protrusions.

In some embodiments, the embossing may be a digital embossing.

In some embodiments, the process may further comprise applying a pre-embossed wear layer on the printing pattern.

The process may further comprise dividing the board element at a separation portion separating a first and a second group of cavities, thereby obtaining at least one board member or at least one panel.

A board dividing position may be based on the position of the printing pattern and/or on the location of the cavities.

Generally herein, the cavities may be created prior to dividing the board element.

The thermoplastic material may comprise thermoplastic polymers, such as polyvinyl chloride, PVC, polyethylene, PE, polypropylene, PP, thermoplastic polyurethane, TPU, or polyethylene terephthalate, PET, ethylene-vinyl acetate, EVA, polyamide, PA, polystyrene, PS, polyvinyl acetate, PVAc, polymethyl methacrylate, PMMA, polyvinyl butyral, PVB, polycarbonate, PC, acrylonitrile butadiene styrene, ABS, polyacrylamide, PAM, polybutylene terephthalate, PBT, chlorinated PVC, CPVC, or a combination thereof. Generally herein, the thermoplastic material may comprise amorphous polymers and/or semi-crystalline polymers.

The thermoplastic material may comprise a, preferably inorganic or organic, filler. A degree of filler may exceed 40 wt %, preferably exceeding 60 wt %, such as 50-90 wt % or 60-80 wt %.

The filler may comprise, or may be, an inorganic filler, such as a mineral material, for example calcium carbonate (CaCO₃), limestone, such as chalk, talc, fly ash, or a stone material, such as stone powder.

The filler may comprise, or may be, an organic filler, such as a wood material, a bamboo material, cork or rice husks. For example, the wood material may be wood fibres and/or wood dust, and the bamboo material may be bamboo dust.

An amount of thermoplastic polymers, such as PVC, may be 10-40 wt %, such as 15-35 wt %.

The core may be a rigid core. A degree of plasticizer in the core may be less than 5 wt %, preferably less than 3 wt % or less than 1 wt %. The core, such as the rigid core, may have a modulus of elasticity, or Young's modulus E, of 1-10 GPa, such as 2-8 GPa, preferably determined in accordance with ISO 178:2010/A1:2013.

The board element or panel herein may be a Luxury Vinyl Tile (LVT tile), a Stone Plastic (Polymer) Composite panel or Solid Polymer Core panel (SPC panel), or an Expanded Polymer Core panel (EPC panel), also known as Water Proof Core panel or Wood Plastic Composite panel (WPC panel).

In some embodiments, the polymer-based material may comprise a thermosetting material, such as polyurethane, PU, a melamine formaldehyde resin, an epoxy resin, a polyester resin, urea-formaldehyde, UF, or phenol formaldehyde, PF.

In accordance with a second aspect of the disclosure, there is provided a process for dividing a board element. The process comprises providing a board element, preferably at least comprising a substrate comprising a polymer-based material, such as a thermoplastic material, and a plurality of cavities in a rear side of the substrate, dividing the board element, thereby obtaining at least one board member or at least one panel, and coordinating a board dividing position with a location of the cavities.

Embodiments of the second aspect are largely analogous to those of the first aspect described herein, whereby reference is made thereto. In particular, the embodiments related to the creation of cavities, the arranging or inclusion of the printing pattern, the dividing of the board element, material choices, such as of thermoplastic material, are included. In particular, the following embodiment is included:

The process may further comprise dividing the board element at a separation portion separating a first and a second group of cavities, thereby obtaining at least one board member or at least one panel.

In accordance with a third aspect of the disclosure, there is provided a process for embossing a board element. The process comprises providing a substrate comprising a polymer-based material, such as a thermoplastic material, and a plurality of cavities in a rear side of the substrate, embossing at least a portion of the substrate comprising a printing pattern on a front side and, optionally, a wear layer, such that an embossed structure in register, EIR, with the printing pattern is obtained, and coordinating a position of the embossed structure with a location of the cavities. Thereby, the board element comprising the substrate and the printing pattern may be obtained.

By means of the third aspect, the position of the printing pattern may not be needed for obtaining the EIR. Embodiments of the third aspect are largely analogous to those of the first aspect described herein, whereby reference is made thereto. In particular, the embodiments related to the creation of cavities, the arranging of the printing pattern, the dividing of the board element, material choices, such as of thermoplastic material, are included.

Generally, all terms used herein, such as in the claims, are to be interpreted according to their ordinary meaning in the technical field, unless explicitly defined otherwise. All references to “a/an/the [element, device, component, means, step, etc.]” are to be interpreted openly as referring to at least one instance of said element, device, component, means, step, etc., unless explicitly stated otherwise. Reference to one or a plurality of “at least one element”, etc., may shortly be referred to as “the element(s)”.

### BRIEF DESCRIPTION OF THE DRAWINGS

The disclosure will in the following be described in connection to exemplary embodiments and in greater detail with reference to the appended exemplary drawings, wherein:

FIGS. 1a-1c illustrate in side views embodiments of an arrangement for manufacturing a board element and its use.

FIGS. 2a-2c illustrate in side views embodiments of an arrangement for manufacturing a board element and its use.

FIGS. 2d-2f illustrate embodiments of a print layer in top views.

FIG. 3a illustrates in a bottom view, a cross-sectional side view, and a top view an embodiment of a board element, e.g., obtainable by the arrangement in any of FIGS. 1a-1c and 2a-2c.

FIGS. 3b-3d illustrate an embodiment of a panel obtainable from the board element in FIG. 3a in a bottom view (FIG. 3b), a cross-sectional side view (FIG. 3c), and a top view (FIG. 3d).

FIGS. 3e-3f illustrate in cross-sectional side views embodiments of a board element dividable into panels.

FIGS. 3g-3h illustrate in cross-sectional side views embodiments of a board element obtainable from the arrangement, e.g., in any of FIGS. 1c and 2b-2c.

FIGS. 4a-4c illustrate in cross-sectional side views embodiments of a board element, e.g., obtainable by the arrangement in any of FIGS. 1a-1c and 2a-2c and being dividable into panels.

FIGS. 4d-4e illustrate in a top view (FIG. 4d) and a bottom view (FIG. 4e) an embodiment of a panel, e.g., obtainable from the board element in any of FIGS. 1a-1c, 2a-2c, 3a-3e, 3g-3h and 4a-4c.

FIGS. 5a-5b illustrate in a perspective view (FIG. 5a) and a front view (FIG. 5b) an embodiment of an impression member of an impression device, which for example may be used in any of FIGS. 1b-1c and 2a.

FIG. 6 illustrates a flow chart of embodiments of a process for manufacturing a board element.

### DETAILED DESCRIPTION

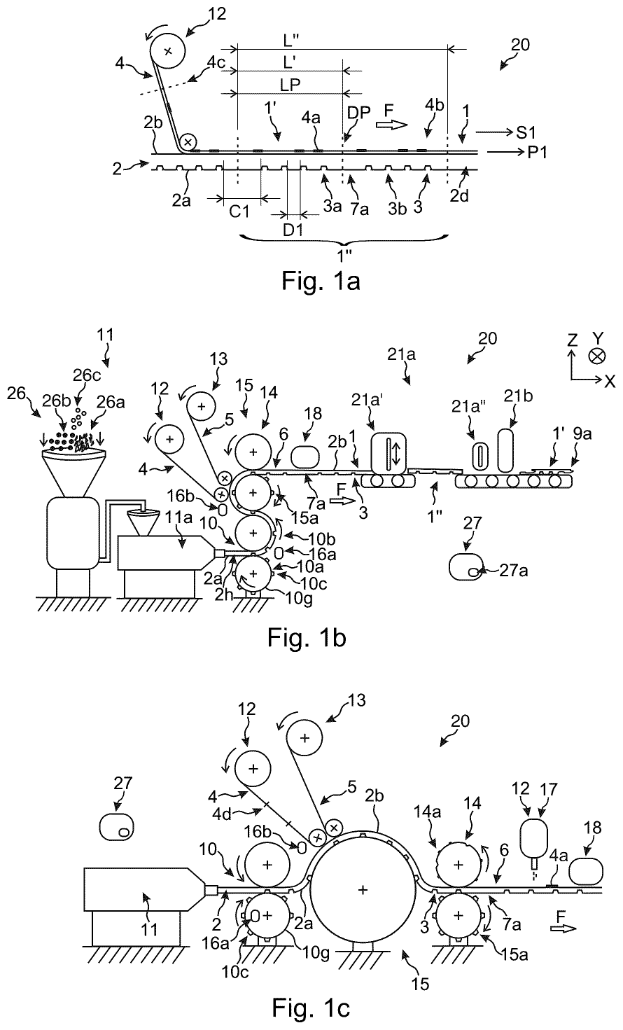

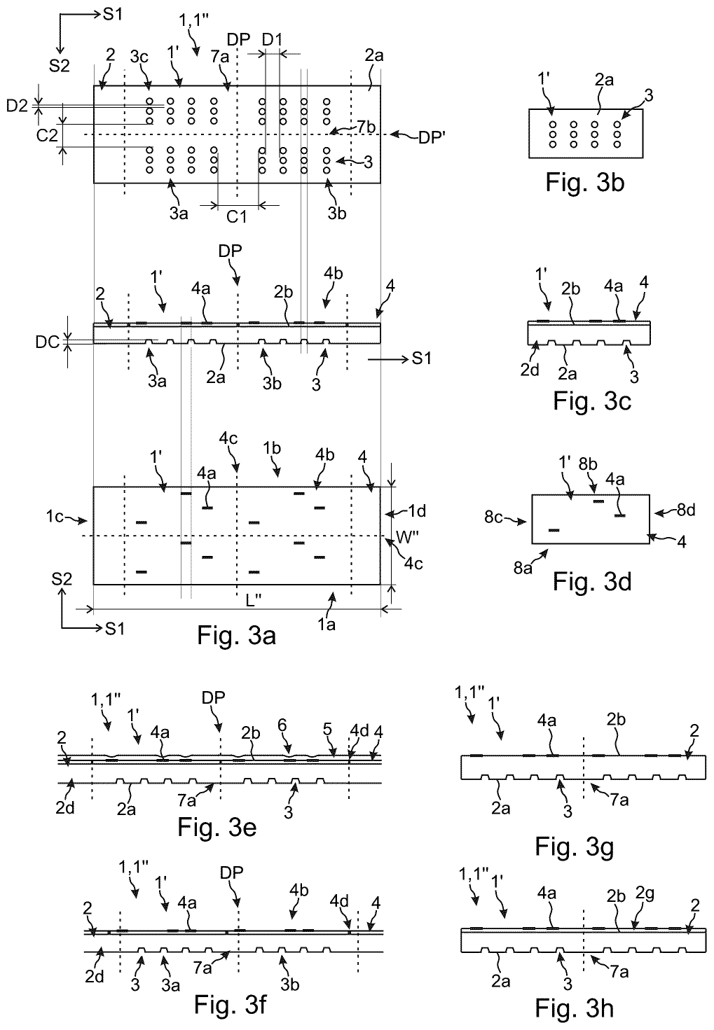

Next, various exemplary embodiments of an arrangement 20 for manufacturing a board element 1, as well as exemplary embodiments of a related board element, will be described with reference to the embodiments in, e.g., FIGS. 1a-1c, 2a-2f, 3a-3h, 4a-4e and 5a-5b. The arrangement 20 is capable of implementing and configured to implement a process for manufacturing such a board element 1 from a substrate 2 comprising a polymer-based material and a plurality of cavities 3 in a rear side 2a of the substrate 2. The cavities may reduce the weight and a material content of the board element. The board element 1 may be rectangular comprising long 1a, 1b and short 1c, 1d edge portions (see, e.g., FIG. 3a), but other shapes of the board element, such as square, are equally conceivable. The substrate 2 or board element 1, such as a panel 1′, herein may have a, preferably maximal, thickness T of 2-10 mm.

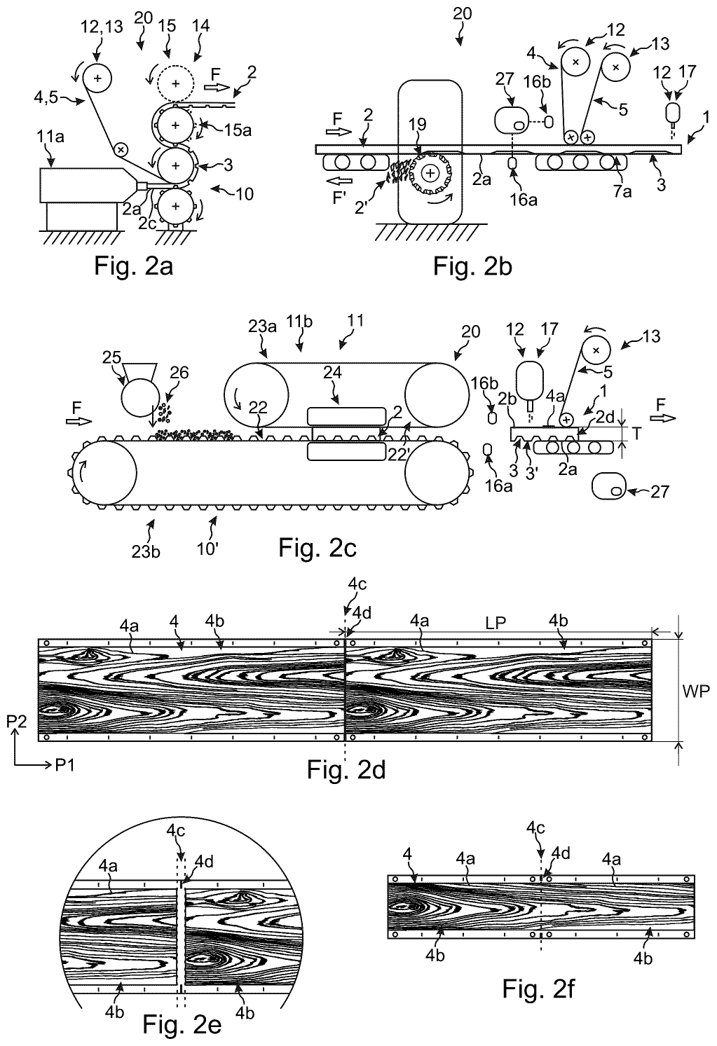

The arrangement 20 extends in a longitudinal X, a transverse Y, and a vertical Z direction. As shown in, e.g., FIGS. 1a-1c and 2a-2c, the arrangement 20 may comprise a print application unit 12 and, optionally, a wear layer application unit 13, preferably adapted to apply, such as laminate or adhere, a print layer 4 and, optionally, wear layer 5, to a front side 2b of the substrate 2 after or during its forming. The application of the print 4 and/or wear 5 layer(s) may be continuous. Preferably, the substrate 2 may be displaced along a feeding direction F during operation of the arrangement 20 and the unit(s) 12 and/or 13 may comprise at least one roller. In some embodiments, however, the application may be discontinuous or intermittent, for example utilizing a static press, such as a multi-daylight press or a short-cycle press.

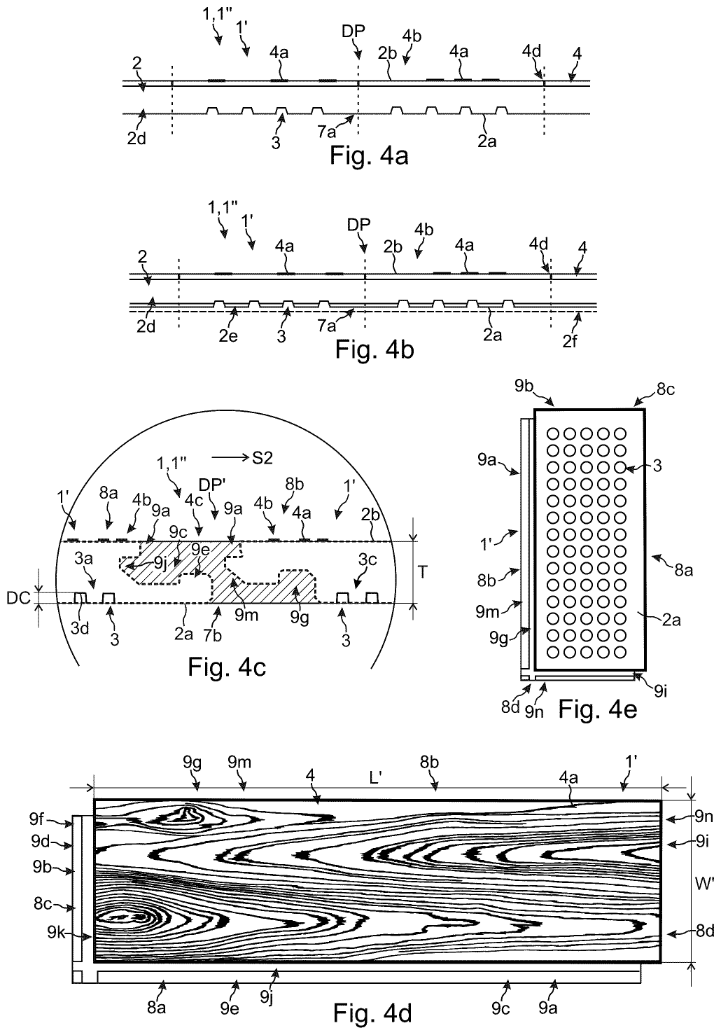

The print layer 4 comprises a, preferably predetermined, printing pattern 4a, see, e.g., FIGS. 1a, 2d-2f, 3a-3f and 4a-4d. In non-limiting examples, the printing pattern 4a may be a wood pattern or a stone pattern. For example, the printing pattern 4a may be digitally printed, such as by inkjet printing, or may be formed by rotogravure. Preferably, the print layer 4 comprises print layer sections 4b, at least one of which comprises the printing pattern 4a. As shown in, e.g., FIGS. 1a, 2d-2e, 3a, 3e and 3f, the printing pattern 4a may be repeated in the print layer sections 4b. The repeated printing pattern may be discontinuous (see, e.g., FIGS. 2d and 2e) or continuous (cf., e.g., the transition at 4c in FIG. 2f, although the printing patterns are not repeated therein). Alternatively, as shown in, e.g., FIGS. 2f, 4a and 4b, the printing pattern 4a may vary between the print layer sections 4b. The varying printing pattern may be discontinuous or continuous (see, e.g., FIG. 2f).

The print layer 4 may extend along a first P1 and a second P2 direction, which is perpendicular to the first direction P1. At least during a part of the operation of the arrangement 20, the first direction P1 may extend essentially in parallel with the feeding direction F. The print layer sections 4b may be directly juxtaposed, such that edge sections 4c between them extend essentially along a line, preferably being parallel with the second direction P2, see, e.g., FIGS. 2d and 2f. Alternatively, and as shown in, e.g., FIGS. 2e and 4c, the print layer sections 4b may be separated along the first direction P1, and optionally the second direction P2, whereby the edge sections 4c may form intermediate regions extending along the first and/or second directions.

The print layer 4 may comprise marks 4d adapted to provide position data of the print layer 4, such as of the printing pattern 4a. For example, the print layer sections 4b may be separated from each other by marks 4d, thereby preferably being edge marks.

The print layer 4, optionally comprising print layer sections 4b, may be configured to be fed along the feeding direction F during operation of the arrangement 20, preferably by means of at least one roller of the print application unit 12. The print layer sections 4b may have a defined length LP, preferably along the first direction P1, which may correspond to a defined length L′, L″ of one or several panels 1′ or board members 1″, such as of their front side 2b, see, e.g., FIGS. 1a, 2d, 3a and 4d. In operation of the arrangement 20, the lengths L′, L″, LP preferably extend along the feeding direction F.

A width WP of the print layer sections 4b, preferably along the second direction P2, may essentially correspond to a width W′, W″ of the at least one or several panels 1′ or board members 1″, such as of the front side 2b, see, e.g., FIGS. 2d, 3a and 4d.

In some embodiments, and as shown in, e.g., FIGS. 1c and 2b-2c, the print application unit 12 may comprise a digital printing unit 17 adapted to form a printing pattern 4a in the form of a digital print on the board element 1, preferably after its forming. For example, the digital printing unit 17 may comprise an inkjet printer. The printing pattern 4a may be printed directly on the substrate 2 (see, e.g., FIG. 3g) or on an upper layer 2g attached, such as laminated or adhered, to the substrate 2 (see, e.g., FIG. 3h), for example by means of rollers in the arrangement 20. The upper layer 2g may comprise a thermoplastic material, such as PVC, and a filler, such as an inorganic filler, e.g., a mineral material. In complete analogy with the discussion above, a wear layer 5 may optionally be applied on the digitally printed substrate 2 or upper layer 2g, for example in the form of a printed polymer-based sheet, such as a foil or a film, or a coating, such as an EB or UV coating. The wear layer application unit 13 may be arranged downstream of the digital printing unit 17, e.g., as shown in FIG. 2c. In some embodiments, the digital printing unit 17 may be located between the impression 10 and embossing 14 devices (discussed below) in FIG. 1c.

The arrangement 20 may comprise a substrate forming arrangement 11, see, e.g., FIGS. 1b-1c, 2a and 2c. The substrate forming arrangement 11 may comprise an extruder 11a, such as a co-extruder (see FIGS. 1b-1c and 2a), or a press 11b, such as a double-belt press (see FIG. 2c) and, preferably, a roller assembly 15 for calendaring the substrate 2, e.g., in the form of an extrudate from the extruder 11a. For example, a material container communicating with the extruder 11a may be configured to receive a thermoplastic material 26 comprising thermoplastic polymers 26a and preferably a filler 26b and/or additives 26c, for example via a hopper. Other features and characteristics of the substrate forming arrangement 11 have been described in WO 2023/249536 A1, e.g., on page 18, lines 1-16 and FIGS. 1a-1c, which content hereby is explicitly incorporated by reference.

A hardened or cured substrate element 2h from the substrate forming arrangement 11, such as the extrudate, may provide a substrate 2, such as a core 2d, of the board element 1. Alternatively, it may be another layer in the board element 1, such as an upper layer 2g. Optionally, the substrate 2 may comprise additional layers, such as a backing layer 2e and/or an upper layer 2g, for example obtained from a co-extruded substrate 2.

As shown in, e.g., the embodiments in FIGS. 1b-1c, 2a and 5a-5b, the arrangement 20 may comprise an impression device 10 comprising protruding impression elements 10c, preferably being provided downstream of the substrate forming arrangement 11. The impression device 10 may comprise an impression member 10a and a mating member 10b. Other features and characteristics of the impression device 10 have been described in WO 2023/249536 A1, e.g., on page 14, line 6 to page 17, line 3 and FIGS. 1a-1c, 2a-2f, 3a-3e, 4a-4f, 5a-5d, 5f, 11e-11f and 12a-12c, which content hereby is explicitly incorporated by reference. For example, the impression device 10 may comprise an impression roller (see below) for continuous creation of cavities 3 or an impression press plate for continuous or discontinuous creation of cavities 3.

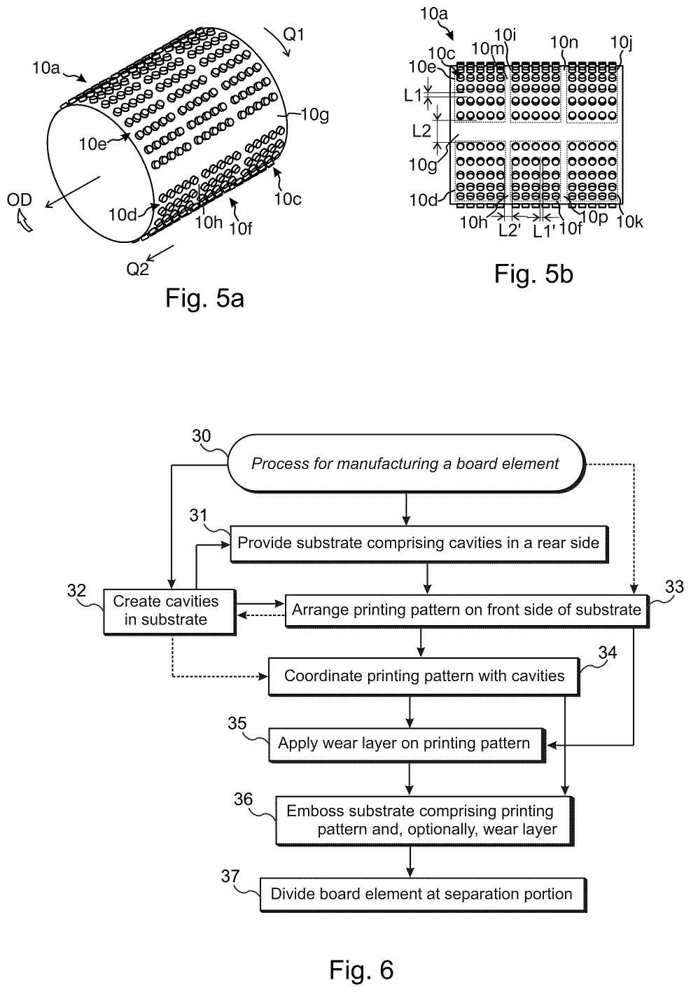

In some embodiments, and as illustrated in, e.g., FIGS. 1b-1c and 5a-5b, the impression member 10a may comprise a first 10d and a second 10e (or 10f) set of impression elements 10c that are separated from each other along a separation direction Q1 (or Q2) by a blank portion 10g (or 10h). A distance L2 (or L2′) between the impression elements along the separation direction Q1 (or Q2) between the first and the second sets is larger than a distance L1 (or L1′) between the impression elements 10c within each of the first 10d and the second 10e (or 10f) sets. As shown in, e.g., FIGS. 5a-5b, the impression member 10a may sometimes comprise at least two, such as a plurality, of such second sets 10e, 10f, 10i, 10j, 10k along the separation direction(s) Q1 and/or Q2 separated from by a blank portion 10m, 10n, 10p. In non-limiting examples, L1 (or L1′) may be 1-10 mm, preferably 1-5 mm, more preferably 1.5-4 mm and L2 (or L2′) may be 5-100 mm, preferably 10-75 mm, more preferably 12-50 mm. The separation directions Q1 and Q2 may extend along and may be perpendicular to an operational direction OD, such as rotational direction, of the impression member 10a, respectively.

Other features and characteristics of the blank portion 10g and/or 10h have been described in WO 2023/249536 A1, e.g., on page 26, lines 11-22, page 31, lines 12-21 and FIGS. 3b, 5f, 11d-11f and 12a-12c, which content hereby is explicitly incorporated by reference.

As shown in, e.g., in FIG. 2c, the arrangement 20 may in some embodiments comprise a shaping member 10′ comprising at least one shaping unit 22, and preferably a mating member 22′. The shaping member 10′ may be adapted to press, preferably thermoplastic, material between the shaping units 22 and the mating member 22′. Thereby, a substrate 2 and/or protrusions 3′ may be formed, with cavities 3 between the protrusions 3′. The arrangement 20 may comprise an upper 23a and a lower 23b endless belt unit, a pressing member 24, and an application device 25 configured to apply a thermoplastic material 26 on the substrate 2 or in the shaping units 22′, such as by scattering. Other features and characteristics of the shaping member 10′ have been described in WO 2024/091174 A1, e.g., on page 14, line 30 to page 17, line 12 and FIGS. 1a-1c, 2a-2b, 3a-3c, 4a-4d, 5a-5f and 6a-6c, which content hereby is explicitly incorporated by reference.

In yet some embodiments, and as shown in, e.g., FIG. 2b, the arrangement 20 may comprise a processing tool 19, such as a rotating cutting device, adapted to form cavities 3 by removing material 2′ from the rear side 2a. Features and characteristics of the processing tool 19 have been described in WO 2020/180237 A1, e.g., on page 32, lines 3-30, page 55, line 30 to page 56, line 33, page 57, lines 7-25 and FIGS. 1, 2a-2g, 17a-17b and 18a-18b, which content hereby is explicitly incorporated by reference.

The roller assembly 15 may comprise at least three rollers, such as four (see FIGS. 1b and 2a) or five rollers (see FIG. 1c). It is understood that the fourth roller in FIGS. 1b and 2a (see broken line) is optional and may be omitted. Two of the rollers, such as the first two rollers along the feeding direction in FIGS. 1b-1c and 2a, may be the impression 10a and mating 10b members in the form of rollers. Optionally, one or several of the rollers may comprise protruding support elements 15a adapted to support at least an inner portion of the cavities 3, such as during pressing between the rollers or during lamination of a layer 2e, 2f, 2g to the substrate 2. The central roller in FIG. 1c may in some embodiments comprise support elements 15a.

The arrangement 20 may comprise an embossing device 14, such as an embossing roller or an embossing belt, comprising embossing elements 14a, such as depressions and/or protrusions, see, e.g., FIGS. 1b-1c and 2a. The embossing elements (and hence an embossed structure 6) may be smaller than the impression elements 10c (and hence the cavities 3), such as by being 50%, preferably 70%, more preferably 90% smaller than the impression elements (cavities) in height and/or extension. The embossing device 14 may be provided downstream of the print 12 and/or wear layer 13 application unit(s) along the feeding direction F. For example, the embossing device 14 may be embodied as a roller of the roller assembly 15. Optionally, the fourth (topmost) roller along the feeding direction F in the roller assembly 15 in FIG. 1b or 2a may be an embossing roller. For example, a length of the embossing device 14 along the feeding direction F, such as a circumference of an embossing roller, may substantially correspond to a length L′, L″ of a panel 1′ or board member 1″, or a multiple thereof, such as 2, 3 or 4 times the length L′, L″.

Alternatively, or additionally, the arrangement 20 may comprise a digital embossing device 18, preferably provided downstream of the substrate forming arrangement 11 along the feeding direction F.

As shown in, e.g., FIG. 1b, but is conceivable in combination with any embodiment herein, such as in FIGS. 1a, 1c and 2a-2c, the arrangement 20 may further comprise a board dividing device 21a and/or a profiling unit 21b. The board dividing device 21a may be configured to divide the board element 1 into at least one panel 11, such as at least two panels 1′. Dividing the board element 1 into one panel 1′ means cutting or otherwise machining the board element 1 to form one panel 1′ and remnants. The profiling unit 21b may be adapted to produce, preferably machine, a locking device 9a, 9b on at least one edge portion 1a, 1b, 1c, 1d of the board element 1 in the form of a panel 1′ or at least one panel 1′ into which the board element has been divided. For example, a locking device 9a and/or 9b may be produced on long 8a, 8b and/or short 8c, 8d edge portions of the panel 1′.

The arrangement 20 may comprise a sensor 16a and/or an indicator 16b, any or both of which for example may be an electric sensor, a mechanical sensor, an optical sensor, or an encoder. The sensor 16a may be configured to sense a position, such as an angular position, of the impression device 10, such as of the impression member 10a, which may be a roller. In other embodiments, the sensor 16a may be configured to sense a position of the shaping member 10′ or processing tool 19. Alternatively, or additionally, the sensor 16a may be configured to sense a location of the rear side 2a and/or of the cavities 3. Moreover, the indicator 16b may be configured to sense a position of the print layer 4, for example by means of the marks 4d. Alternatively, or additionally, position data of the front side 2b may be sensed by the indicator 16b. Data sensed by the sensor 16a and/or indicator 16b may be configured to be transmitted to a control unit 27, such as by wireless or wired communication. The data may be transmitted in the form of a, preferably digital, signal. The control unit 27 may comprise a computer unit 27a comprising a processor. In exemplary embodiments, coordinating a position of the printing pattern 4a with a location of the cavities 3 includes sensing a first position of the printing pattern 4a and/or of a device configured to form the printing pattern 4a, sensing a second position of the cavities 3 and/or of a device configured to form the cavities 3, and adjusting a formation of the printing pattern 4a and/or of the cavities 3 based on the first and second positions.

The arrangement 20 in, e.g., any of FIGS. 1a-1c and 2a-2c, is capable of implementing and configured to implement a process for manufacturing a board element 1 comprising a décor structure, preferably in accordance with embodiments of the first aspect disclosed herein. The flow chart in FIG. 6 illustrates embodiments of such a process (Box 30).

First, a substrate 2 comprising a polymer-based material, such as a thermoplastic material, and a plurality of cavities 3 in a rear side 2a is provided (Box 31). For example, the substrate 2 may be preformed (see, e.g., FIGS. 1a and 2b) or it may be formed by the substrate forming arrangement 11, such as under heat, preferably under pressure and/or by (co-) extrusion (see, e.g., FIGS. 1b-1c, 2a and 2c). The cavities 3 may be preformed in the substrate 2 or they may be created by the arrangement 20 (Box 32), for example by impressing a substrate portion 2c by the impression device 10 or by removing material by the processing tool 19, preferably after forming the substrate 2.

Alternatively, the substrate 2 and/or protrusions 3′ may be formed by the shaping member 10′ with cavities 3 between the protrusions 3′. In a first example, the cavities 3 may be created while forming the substrate 2 (see, e.g., FIG. 2c herein and also in FIGS. 4a-4b and 6c of WO 2024/091174 A1). In a second example, the cavities 3 may be created after forming the substrate 2 (see, e.g., FIGS. 1a-1c, 2a-2d, 3a-3c and 6b of WO 2024/091174 A1).

The substrate 2 may comprise a first 3a and a second 3b and/or 3c group of cavities 3 which are separated by a separation portion 7a and/or 7b (see, e.g., FIG. 3a), preferably along a first S1 and/or a second S2 (horizontal) substrate direction. A distance C1 (or C2) between the cavities 3 along the first substrate direction S1 (or second substrate direction S2) between the first 3a and the second 3b (or 3c) group preferably is larger than a distance D1 (or D2) between the cavities 3 within each of the first 3a and the second 3b (or 3c) groups. The separation portion(s) 7a, 7b may function as a dividing portion DP, DP′ of the board element 1 or a strengthening board area. The skilled artisan will appreciate that in some embodiments, the substrate 2, and hence the board member 1″ or panel 1′, may comprise a plurality of such separation portions 7a and/or 7b.

The first 3a and second 3b and/or 3c group of cavities 3 may be preformed. Alternatively, they may be created, for example by impression, preferably by means of an impression member 10a comprising a first 10d and a second 10e (or 10f) separated sets of impression elements 10c described above. Alternatively, they may be created by the shaping member 10′ or the processing tool 19 of the types described above.

The printing pattern 4a, such as the print layer sections 4b or the digital print, may be arranged on the front side 2b at least partially between the separation portions(s) 7a and/or 7b, such as between the dividing portion(s) DP, DP′.

In any of the embodiments herein, a depth DC of the cavities 3, preferably from the rear side 2a to an innermost bottom wall 3d of the cavities 3, may be at least 0.10, preferably at least 0.20 or at least one third of a, preferably maximal, thickness T of the substrate 2. For example, 0.10*T≤DC≤0.70*T, 0.20*T≤DC≤0.70*T, or 0.30*T≤DC≤0.70*T, such as 0.35*T≤DC≤0.65*T.

The thermoplastic material of the substrate 2 may comprise thermoplastic polymers, such as PVC, PE, PP, TPU, PET, EVA, PA PS, PVAc, PMMA, PVB, PC, ABS, PAM, PBT, CPVC, or a combination thereof, preferably in an amount of 10-40 wt %, such as 15-35 wt %. The thermoplastic material may further comprise an inorganic or organic filler, preferably in an amount exceeding 40 wt %, more preferably exceeding 60 wt %, such as 50-90 wt % or 60-80 wt %. For example, the inorganic filler may be a mineral material, for example CaCO₃, limestone, such as chalk, talc, fly ash, or a stone material, such as stone powder. In some embodiments, the core 2d may be a rigid core.

A printing pattern 4a is thereafter arranged on the front side 2b of the substrate 2 by a print application unit 12, such as a print roller (Box 33). A print layer 4 comprising a printing pattern 4a may be applied on, such as laminated or adhered to, the front side 2b and/or a printing pattern 4a may be digitally printed on the front side 2b by the digital printing unit 17. The print layer 4 may be applied on the front side by pressing it thereto, optionally under heat. A position of the printing pattern 4a is coordinated with a location of the cavities 3 (Box 34), preferably along the first S1 and/or second S2 substrate direction(s).

The coordination may be obtained by synchronizing the print application unit 12 with the impression device 10, the shaping member 10′, or the processing tool 19. Generally, at least one selected from the group consisting of location data of the cavities 3, position data of the print layer 4, location data of the substrate 2, such as of the rear 2a and/or front 2b side, and position data of the impression device 10, shaping member 10′ or processing tool 19, may provide input to the print application unit 12 and/or the board dividing device 21a about said synchronization and/or a board dividing position (also relevant for embodiments of the second aspect herein). In particular, location data of the cavities 3 and position data of the print layer 4 may provide such input.

By way of example, the location data of the cavities 3 may be obtained by combining the location data of the substrate 2, such as of the rear 2a and/or front 2b side, which may be sensed by the sensor 16a and/or the indicator 16b, and position data of the impression device 10, shaping member 10′, or processing tool 19, which may be sensed by the sensor 16a. The substrate location data and the position data may be transmitted to the control unit 27. Alternatively, the sensor 16a may directly sense the location of cavities 3 and may transmit the corresponding data to the control unit 27.

Moreover, the position data of the print layer 4 may, for example, be obtained by detecting the marks 4d by the indicator 16b and may be transmitted to the control unit 27. Preferably, the position of the print layer 4 is sensed before applying it on the front side 2b.

In some embodiments, the control unit 27, such as the computer unit 27a therein, may determine an operation of the print application unit 12, preferably in relation to the front side 2b. For example, the control unit 27 may communicate with the print application unit 12 via wired or wireless communication. Thereby, the print layer 4 or digital print may be more precisely applied to the front side 2b.

In some embodiments, the coordination may be obtained by controlling the arranging of the printing pattern 4a on the front side 2b based on a print schedule, preferably by controlling the print application unit 12. The print schedule may be a delivering schedule and/or a tension regulation schedule of the print layer 4 or a digital print schedule of the digital print unit 17. The print schedule may be determined based on the location data of the cavities 3 and/or position data of the print layer 4, which preferably is continuously or intermittently fed to the control unit 27. When the printing pattern 4a is digitally printed, the print schedule may be determined based on the location data of the cavities 3 and/or position data of the front side 2b. The control unit 27, such as the computer unit 27a therein, may determine the print schedule by processing said location data and/or position data. The print schedule may be based on the position data of the front side 2b.

In some embodiments, the print schedule may comprise a correcting scheme of components of the print 12 and/or the wear 13 application unit. For example, a deliver rate and/or a tension of the print layer 4 may be adjusted based on the print schedule.

At least one print layer section 4b, such as a plurality of them, may be coordinated with the location of the cavities 3. When the cavities 3 are provided in a first 3a and a second 3b and/or 3c group, the position of the printing pattern 4a may be coordinated with a location of the separation portion(s) 7a and/or 7b. For example, the edge sections 4c and the separation portion(s) 7a and/or 7b may be arranged at essentially the same position, such as along the first S1 and/or second S2 substrate direction(s).

In some embodiments, rollers of the impression device 10, preferably the impression member 10a, and rollers of the print application unit 12 may be connected to each other, such that they move in unison. Preferably, the connection is mechanical, for example by means of a belt, chain or gear configuration, or similarly. Thereby, virtually no, or even no, relative dislocation between the rollers may occur and a coordination between the position of the printing pattern 4a and the location of the cavities 3 may be obtained.

In some embodiments, and as illustrated by the broken lines in FIG. 6, the cavities 3 may be created (Box 32) after arranging the printing pattern 4a on the front side 2b (Box 33), see, for example, FIG. 2b where the substrate 2 is fed along the feeding direction F′ (being opposite to the feeding direction F mentioned elsewhere herein). The cavities 3 may be created as described elsewhere herein, for example by impressing a substrate portion 2c by the impression device 10, by removing material by the processing tool 19, or by forming protrusions 3′ by the shaping member 10′ with cavities 3 between the protrusions 3′. A print layer 4 comprising a printing pattern 4a may be applied and/or a printing pattern 4a may be digitally printed on the front side 2b. A location of the cavities 3 is coordinated with a position of the printing pattern 4a (Box 34), preferably along the first S1 and/or second S2 substrate direction(s). The coordination may be obtained by synchronizing the print application unit 12 with the impression device 10, the shaping member 10′, or the processing tool 19.

In some embodiments, the coordination may be obtained by controlling the creation of the cavities 3 in the rear side 2a based on a cavity creation schedule, preferably by controlling the impression device 10, the shaping member 10′, or the processing tool 19. Preferably, the cavity creation schedule may be determined based on location data of the substrate 2, such as of the rear side 2a, and/or position data of the printing pattern 4a. The control unit 27 may determine the cavity creation schedule by processing the location data and/or position data.

When the cavities 3 are created after arranging the printing pattern 4a on the front side 2b, the location of the cavities 3 may be coordinated with at least one print layer section 4b, such as a plurality of them. When the cavities 3 are created in a first 3a and a second 3b and/or 3c group, a location of a separation portion(s) 7a and/or 7b may be coordinated with the position of the printing pattern 4a. For example, the separation portion(s) 7a and/or 7b and the edge sections 4c may be arranged at essentially the same position, such as along the first S1 and/or second S2 substrate direction(s).

In some embodiments, such as any of FIGS. 1a-1c and 2a-2c, a wear layer 5 may be applied on the printing pattern 4a (Box 35), preferably on the print layer 4 and/or the digital print, by the wear application unit 13.

At least a portion, such as an entirety, of the substrate 2 comprising print layer 4 and/or the digital print and, optionally, a wear layer 5, may be embossed, such that an embossed structure 6 in register with the printing pattern 4a is obtained (Box 36). A position of the embossed structure may be coordinated with a location of the cavities. For example, the embossing may be performed by the embossing device 14 or it may be a digital embossing performed by the digital embossing device 18. In a first example, the wear layer 5 may be applied to the printing pattern 4a prior to embossing. In a second example, the printing pattern 4a, such as the print layer 4, and the wear layer 5, may be embossed while applying the print layer 4 and the wear layer 5 to the front side 2b. In some embodiments, instead of actively embossing the substrate 2 as described above, a pre-embossed wear layer 5 may be applied on the printing pattern 4a.

Optionally, the embossing may be based on the, preferably determined, print schedule, for example by controlling the embossing unit 14, preferably by means of the control unit 27. For example, the impression device 10, such as the impression member 10a (e.g., roller), may be mutually synchronized with either or both of the print application unit 12 and the embossing device 14, for implementing the printing pattern and cavity location coordination.

Generally herein, the print layer 4 and/or wear layer 5 may be a printed polymer-based sheet, such as a foil or a film, for example comprising PVC. For example, a thickness of the print layer and wear layer may be 0.01-0.10 mm and 0.05-2.0 mm, respectively. Alternatively, the wear layer 5 may be a coating, for example an EB coating or a radiation cured coating, such as UV coating.

FIGS. 3a, 3e, 3g-3h and 4a-4c illustrate embodiments of a board element 1 obtained by any of the processes above, with coordinated printing patterns 4a and cavities 3. FIG. 4c schematically illustrates a region around long edge portions 8a, 8b of two panels 1′ into which the board element 1 is configured to be divided. FIG. 3f illustrates an example where the coordination is suboptimal since the printing pattern 4a is not satisfactorily coordinated with the cavities 3 and/or since the marks 4d are non-aligned with the dividing portion DP.

In some embodiments, a lower layer 2e, for example backing layer, such as a balancing layer, and/or a cover layer 2f, such as a foam layer, may be attached, such as laminated or adhered, to the rear side 2a, e.g., after creating the cavities 3.

The board element 1 may subsequently be divided by the board dividing device 21a into at least one panel 1′, such as at least two panels 1′. Preferably, the board element 1 is divided at the separation portion(s) 7a and/or 7b (Box 37). For example, the board element 1 may be divided into board members 1″ by a first dividing unit 21a′, which in turn may be further divided into at least two panels 1′ by a second dividing unit 21a″, wherein the panels preferably are divided into a substantially final format. Any dividing disclosed herein may be implemented by machining, such as by using knives, rotating cutting tools, and similarly. FIGS. 3a-3e, 3g-3h and 4a-4e illustrate embodiments of a panel 1′ or board member 1″ obtainable after the dividing.

The board element 1 may be divided from the front side 2b toward the rear side 2a or vice versa. Generally herein, the board dividing position, for example determined by the control unit 27, may be based on the position of the printing pattern 4a and/or on the location of the cavities 3. Alternatively, or additionally, the board dividing position may be based on the location of the separation portion(s) 7a and/or 7b. For example, the marks 4d may be correlated, for example being essentially aligned, with the separation portion 7a and/or 7b. It is noted that any of the dividing processes herein may comprise the cutting of a print layer 4 into a size substantially corresponding to that of a board member 1″ or panel 1′.

It is emphasized that according to a second aspect of the disclosure, there is provided a process comprising the dividing of the board element 1 into board member(s) 1″ or panel(s) 1′ by coordinating the board dividing position with the location of the cavities 3. Here, the arranging of a printing pattern 4a on the front side 2b and coordinating it with a location of the cavities 3 is not necessarily needed, although not excluded. Embodiments of the second aspect may comprise any of the acts described herein in relation to the first aspect, separately or in combination (see, e.g., Boxes 31, 32 and 35-37 and, optionally, Boxes 33 and 34).

In any of the embodiments herein, such as in FIG. 6, a locking device 9a, 9b may be produced, preferably machined, on at least one edge portion 1a, 1b, 1c, 1d of the panel(s) 1′ by the profiling unit 21b. A locking device 9a and/or 9b may be produced on long 8a, 8b and/or short 8c, 8d edge portions of the panel 1′. For example, a long (short) edge portion 8a (8c) may comprise a strip 9c (9d) extending horizontally beyond an upper portion of the panel 1′, and a locking element 9e (9f) for horizontal locking by cooperation with a locking groove 9g (9i) arranged in an opposing long (short) edge portion 8b (8d) of an adjacent panel 1′ may be provided thereon, cf. FIGS. 4c-4e. Additionally, the long (short) edge portion 8a (8c) may comprise a tongue groove 9j (9k) for vertical locking by cooperation with a tongue 9m (9n) arranged in the opposing long (short) edge portion 8b (8d) of an adjacent panel 11.

Aspects of the disclosure have mainly been described above with reference to a few embodiments. However, as is readily appreciated by a person skilled in the art, other embodiments than the ones disclosed above are equally possible within the scope of the disclosure. For example, although not always shown explicitly, it is understood that the print layers 4 in any of FIGS. 1b-1c and 2a-2b may comprise a printing pattern 4a. Also, there may be an upper layer 2g provided between the print layer 4 and the substrate 2 in any embodiment herein, such is in any of FIGS. 1a-1c, 2a-2c, 3a-3f and 4a-4d, cf. FIG. 3h. The upper layer 2g may comprise a thermoplastic material, such as PVC, and a filler, such as an inorganic filler, e.g., a mineral material. Moreover, the front side 2b may be digitally printed prior to, or sometimes after, the dividing of the board element. Finally, it is clear to the skilled artisan that the polymer-based material of the substrate 2 in any of FIGS. 1a-1c, 2a-2c, 3a-3h and 4a-4e may be a thermosetting resin, such as PU, a melamine formaldehyde resin, an epoxy resin, a polyester resin, UF or PF.

1. A process for manufacturing a board element comprising a substrate and a printing pattern, the process comprising:
providing a substrate comprising a polymer-based material and a plurality of cavities in a rear side;
arranging a printing pattern on a front side of the substrate; and
coordinating a position of the printing pattern with a location of the cavities.

2. The process according to claim 1, wherein said arranging the printing pattern comprises digitally printing said front side.

3. The process according to claim 1, wherein said arranging the printing pattern comprises applying a print layer on said front side.

4. The process according to claim 3, wherein the print layer is a printed polymer-based sheet.

5. The process according to claim 3, wherein the print layer comprises print layer sections, and wherein at least one print layer section comprising said printing pattern is applied on said front side.

6. The process according to claim 5, wherein the printing pattern is repeated in the print layer sections.

7. The process according to claim 1,
wherein the printing pattern is repeated as regions, separated by edge sections,
wherein the cavities form a cavity pattern that is repeated as regions separated by separation portions, and
wherein the coordinating includes arranging the edge sections and the separation portions at essentially same horizontal positions.

8. The process according to claim 1, further comprising creating said cavities in the rear side by impressing a substrate portion by an impression device comprising impression elements, and arranging the printing pattern on said front side by a print application unit, the print application unit being synchronized with the impression device for obtaining said coordination of the printing pattern and the cavities.

9. The process according to claim 1, further comprising determining a print schedule based on location data of the cavities and/or position data of a print layer, and controlling said arranging of the printing pattern on the front side based on the determined print schedule.

10. The process according to claim 1, wherein said coordinating includes:
sensing a first position of the printing pattern and/or of a device configured to form the printing pattern;
sensing a second position of the cavities and/or of a device configured to form the cavities; and
adjusting a formation of the printing pattern and/or of the cavities based on the first and second positions.

11. The process according to claim 1, further comprising applying a wear layer on the printing pattern.

12. The process according to claim 1, further comprising embossing at least a portion of the substrate comprising the printing pattern and, optionally, a wear layer, such that an embossed structure in register with the printing pattern is obtained.

13. The process according to claim 1, further comprising dividing the board element at a separation portion separating a first and a second group of cavities, thereby obtaining at least one board member or at least one panel.

14. The process according to claim 13, wherein a board dividing position is based on the position of the printing pattern and/or on the location of the cavities.

15. A process for dividing a board element, the process comprising:
providing a board element comprising a substrate comprising a polymer-based material, and a plurality of cavities in a rear side;
dividing the board element, thereby obtaining at least one board member or at least one panel; and
coordinating a board dividing position with a location of the cavities.

16. The process according to claim 15, wherein the board element comprises a printing pattern.

17. The process according to claim 16, further comprising arranging the printing pattern by digitally printing a front side.

18. The process according to claim 16, further comprising applying a wear layer on the printing pattern.

19. A process for embossing a board element, the process comprising:
providing a substrate comprising a polymer-based material, and a plurality of cavities in a rear side;
embossing at least a portion of the substrate comprising a printing pattern on a front side and, optionally, a wear layer, such that an embossed structure in register, EIR, with the printing pattern is obtained, thereby obtaining the board element comprising the substrate and the printing pattern; and
coordinating a position of the embossed structure with a location of the cavities.

20. The process according to claim 19, further comprising arranging the printing pattern by digitally printing said front side.
